(19) United States
(12) Patent Application Publication
(10) Pub. No.: US 2022/0164905 A1
(43) Pub. Date: May 26, 2022

(54) Home Services Software Solution With Live Communication

(71) Applicant: Maria T. Reutov, Wasilla, AK (US)

(72) Inventor: Maria T. Reutov, Wasilla, AK (US)

(21) Appl. No.: 17/233,096

(22) Filed: Apr. 16, 2021

Related U.S. Application Data
(60) Provisional application No. 63/117,196, filed on Nov. 23, 2020.

(51) Int. Cl. G06Q 50/16; G06F 16/9035; G06F 16/909

(52) U.S. Cl. CPC G06Q 50/16; G06F 16/909; G06F 16/9035

(57) ABSTRACT

Systems and methods are provided for establishing effective communication between various participants in buying and selling real estate and related services. The system provides listings of professionals within the user's defined location, allowing the user to select one or more desired professionals so that the system provides effective communication between the user and any such professionals. The system also provides the ability to chat while exchanging pictures, videos, and documents needed for real estate transactions.

### FIELD OF THE INVENTION

The present invention generally relates to software. More specifically, the present invention relates to software that is designed to provide users with a variety of information related to buying, selling, and upkeeping a property, in real time.

### BACKGROUND OF THE INVENTION

A software application that is designed to efficiently provide users with information relevant to buying a property is in demand. People who want to buy or sell a home may require the services of various professionals, including those working in real estate, mortgage brokering, and home services, before finalizing their decision to buy or sell a home.

Traditionally, buyers and sellers have connected using telephone, online, or other directories to find one another and connect with real estate agents who can assist their buying and selling transactions.

A potential buyer who cannot connect with a real estate agent may face the prospect of entering into a contract without actually seeing the property in question. Alternatively, a real estate agent may be seeking potential buyers in the area but have no way of connecting with them.

Because traditional services do not allow real-time communication between real estate agents, buyers, and sellers, making appointments can be inconvenient. Buyers must seek a real estate agent in the area or call the agent listed on the for-sale sign posted at the property but doing so can be time-consuming and inefficient for those seeking information quickly. Thus, a system is needed to solve these problems.

The present invention is intended to address problems associated with and/or otherwise improve on conventional devices through an innovative real estate system that is designed to provide a convenient and effective means of finding real estate agents and other related professionals and communicating in real time while incorporating other problem-solving features.

### SUMMARY

Embodiments of the present invention address deficiencies of the art in respect to the process of buying/selling a home quickly and efficiently and provide a novel and nonobvious method, system, and computer program product with which homeowners, home buyers, renters, landowners, investors, and home sellers can find professionals in their area who can assist in the buying/selling process.

In one embodiment, the present invention provides a process that works like a directory system, so that a user can click 1 to 3 buttons and find exactly whom he or she is looking for. For example, a user who wishes to find a professional in the area may click a button and then be asked what general service he or she is looking for. Yet another button can be provided for selection services (e.g., buying a house, selling a house). The present invention can also be used to request home professionals such as plumbers, cleaners, landscapers, home designers, and other home related services.

In another embodiment, a user can be asked in which particular location he or she is looking for a professional. Within some radius of the selected location, all the professionals who can complete the task at hand may populate a list. This list may feature various information about the professionals, featuring a picture of the professional, a rating, the professional's name, and the number of times the professional has been favorited. After a user decides on one or more professionals in the list, the user can click on a corresponding listing and be redirected to the professional's profile page, which may include some general business information, general user information, a favorited count, a portfolio, events created by the professional, the professional's description, and a chat button that the user can click to start a chat with the professional.

After a user clicks the chat button, a new chat session can be created. The user can use the chat window to chat with the professional. Additional professionals can be added to the chat session, and pictures, files, messages, and the like can be sent over the chat session.

In yet other embodiments, the chat session can automatically generate a list of additional professionals related to the user's desired service. If the user believes that additional professionals should be on the chat, the user can add them to the chat session.

The present invention may save much time previously spent in locating and communicating with professionals who can efficiently provide a user's desired services. Users can easily find people in the area and begin chatting with them quickly and efficiently to request the desired services.

### BRIEF DESCRIPTION OF THE DRAWINGS

FIG. 1 is an illustration of an exemplary block representation of the present invention.

FIG. 2 is an illustration of one embodiment of the present invention in a network environment.

FIG. 3 is a block diagram illustrating one embodiment of the registration step and the connection step of the present invention.

FIG. 4 is a diagram illustrating one embodiment of the user interface of the present invention displayed with web buttons.

FIG. 5 is a diagram illustrating one embodiment of the display step of the present invention.

FIG. 6 is an illustration of one embodiment of the user interface of the present invention showing the professionals within the search boundary.

FIG. 7 is an illustration of one embodiment of the chat server of the present invention connected to the network.

FIG. 8 is an illustration of one embodiment of the user interface of the present invention showing the chat session.

### DETAIL DESCRIPTIONS OF THE INVENTION

All illustrations of the drawings are for the purpose of describing selected versions of the present invention and are not intended to limit the scope of the present invention.

The present invention provides a software application that is designed to help homeowners, home buyers, renters, landowners, investors, and home sellers find others in their area who can assist in buying a house, assist in selling a house, or provide any home related services quickly and efficiently.

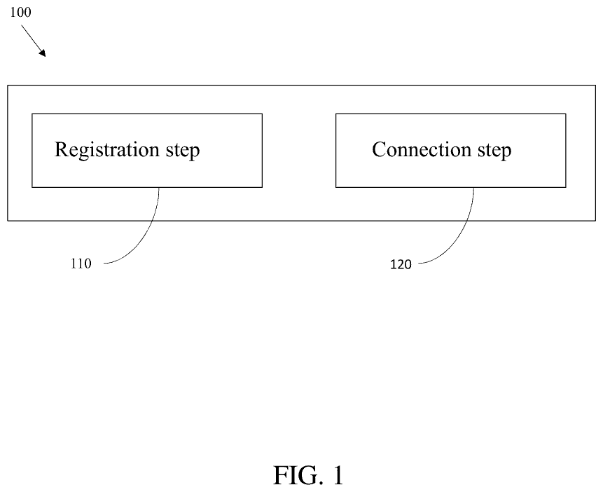

As FIG. 1 shows, the present invention provides a real estate system 100 that comprises a plurality of processors and a plurality of memories, with the latter containing instructions that when executed by a processor trigger a registration step 110 and a connection step 120. The instructions may include routines, programs, objects, data structures, and the like.

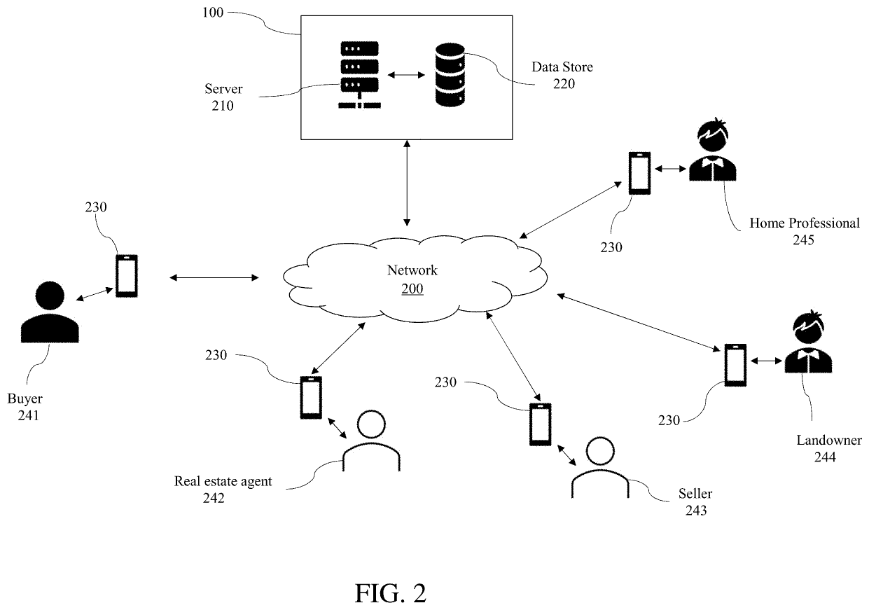

The real estate system 100 can be implemented in a network environment, as shown in FIG. 2, which may comprise one or more servers 210 or one or more data stores 220 for storing all the data generated by the present invention. In some embodiments, the real estate system 100 of the present invention can be loaded on the computing device 230 (that can be used by a user who can be a buyer 241, real estate agent 242, or seller 243, landowner 244, or home professional 245 such as a plumber, cleaner, landscaper, and home designer) which may be communicatively connected to a network 200.

Here it is disclosed that a “user” can be defined as any user or entity that utilizes the present invention to find one or more professionals.

In other embodiments, the real estate system 100 may be deployed on a computing device such that the real estate system 100 is configured as a cloud system.

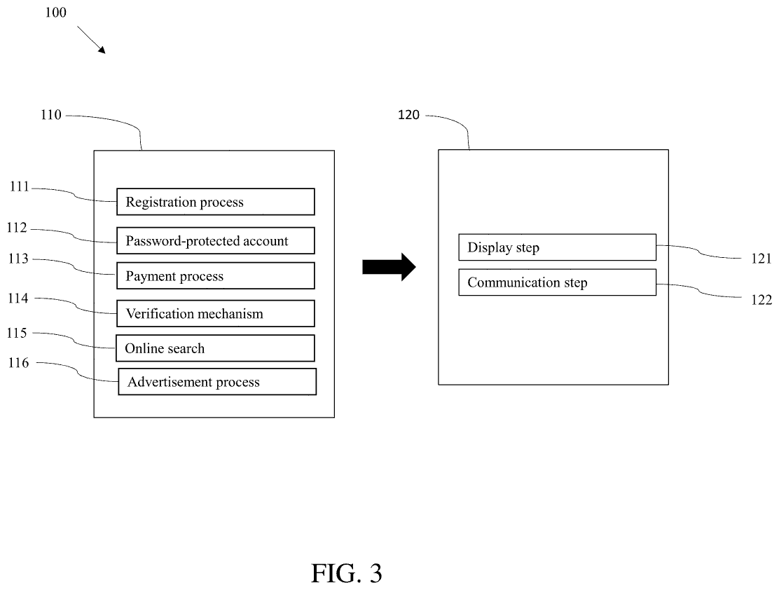

As shown in FIG. 3, the registration step 110 may include a registration process 111, which may include an online registration display (e.g., registration form) that allows a user (e.g., the potential buyers, real estate agents, builders, mortgage brokers, home owners, investors) to input registration information such as company information, personal information, and market area and properties. The online registration display may also allow professionals (e.g., real estate agents, builders, mortgage brokers) to input their registration information. The professionals of the present invention can be all those involved in the buying and selling of houses, including home service personnel (plumbers, cleaners, landscapers, home designers, utility companies), title companies, lawyers, appraisers, insurance companies, lenders, and inspectors.

In one embodiment, the registration step 110 may provide a password-protected account 112 for each user. In other embodiment, the registration step 110 may provide a payment process 113 for registration. The payment process can be an electronic payment method such as a credit card, a debit card, wired money, or other online payment mechanism.

In other embodiments, the registration step 110 may also provide a verification mechanism 114 so that professionals in certain area can be verified as certified professionals. In such embodiments, the professionals can provide their verification numbers such as realtor license numbers.

In some embodiments, the present invention can conduct an online search 115 to generate registration information of the professionals. For example, the registration step 110 can include various processing modules to automatically search for information about the professionals based on a user defined location or a location of the user identified by a computing device that includes a geolocation data receiver (e.g., GPS receiver), such as a smartphone.

In some embodiments, the registration step 110 may include a step to launch a first screen displaying: a start button; and a second screen launched in response to the user pressing the start button on the first screen, the second screen displaying the registration information.

In some embodiments, the registration information can be stored on the user computing device or on any server communicatively connected to it.

The registration step 110 may include an advertisement process 116 through which to retrieve professional information from advertisers, who can be real estate agents, individual sellers of properties, mortgage brokers, and other persons involved in the buying and selling of properties.

The advertisement process 116 may provide a questionnaire, including one served through a web form, through which advertisers can supply the various data needed to place an advertisement.

In one embodiment, advertiser information may include name, business name, date and time of advertisement, properties and/or services offered, commercials (pictures or video), and the like. Such advertiser information can be included in the registration information of the professionals.

The advertisement process 116 may create a profile using advertiser information, then save it in a storage device that may be included in the real estate system 100 of the present invention or communicatively connected to the real estate system 100.

In some embodiments, the registration step 110 may include a modification/update process whereby advertisers can modify and update their profiles.

The connection step 120 may include a process that facilitates communication between the user and the professionals. The connection step 120 may include a display step 121 and a communication step 122, as shown in FIG. 3.

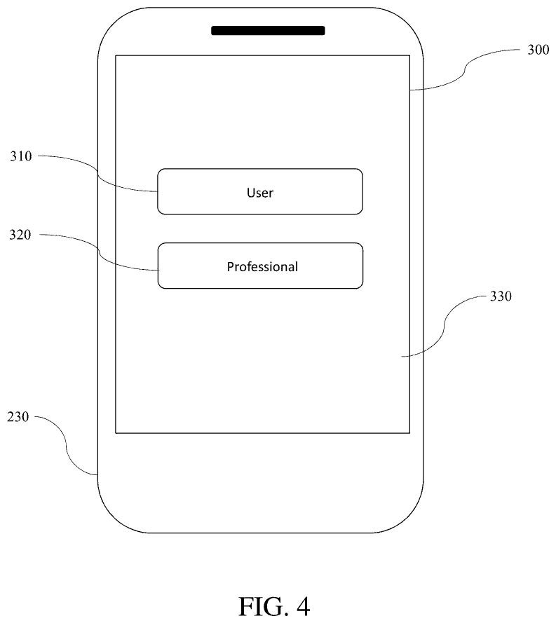

The display step 121 may feature a user interface 300 that initiates a connection between the user and the professionals. For example, the display step may display one or more user web buttons 310 provided for the user and one or more professional web buttons 320 provided for the professionals, on the screen 330 of the computing device 230 of the user and the professionals, as shown in FIG. 4.

A user who wishes to locate a professional in the selected area may click a user web button 310 to initiate a display step 121, shown in FIG. 3, that may be configured to ask what service (e.g., buying and selling) the user is looking for.

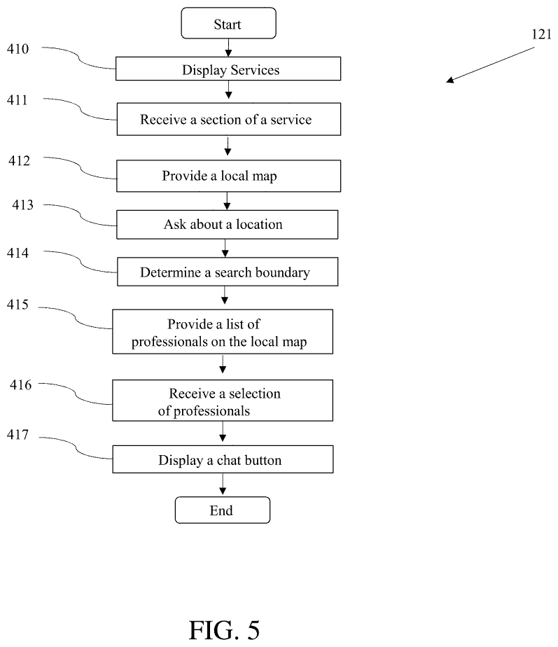

FIG. 5 is a diagram illustrating of the display step 121 of the present invention. At block 410, the display step 121 may display a plurality of service listings of various available services, and provide service selection buttons that the user can use to make choices (e.g., buying house, selling house). The services can be a home service and services from various professionals, where the professionals include, but are not limited to, mortgage brokers, real-estate agents, title companies, lawyers/attorneys, appraisers, insurance, home builders, engineers, home warranty, lenders, and inspectors. The home service may include services from plumbers, cleaners, landscapers, home designers, and utility companies.

At block 411, the display step 121 may receive a selection of a service from the user and at block 412, the display step 121 may provide a local map 510 (shown on FIG. 5). At block 413, the user can be also asked about a particular location in which to locate a professional. At block 414, the display step 121 may determine a search boundary within which to search for professionals based on the user's response about the particular location.

After the user selects the location or describes a radius encompassing the desired area, at block 415, the display step 121 may provide a list of all professionals who offer the desired service in the selected area. The list can be generated based on the registration information and the online search 115 (shown in FIG. 3) conducted by the present invention. The list of professionals may include various information and advertisements, including a picture of each professional's face, customer ratings, name, and number of times favorited. In some embodiments, the list can include a verification number of the professionals such as a realtor license number which can be provided by a realtor in the registration information.

In some embodiments, the display step may provide links or buttons for use in selecting professionals and retrieving their associated profiles stored in the real estate system via the registration step 110 or in electronically redirecting the user to the professional's online profile, which may include general business information, general information, number of times favorited, and other related data.

Once the user selects one or more professionals from the list, display step 121 may receive the selection of the professionals at block 416 and at block 417, the user may be provided with a chat button that can be clicked to initiate the communication step 122 (shown in FIG. 3) and display a chat window on the computing device 230 (shown in FIG. 2) of the user and the professionals, so that the user can start a chat session with other one or more professionals.

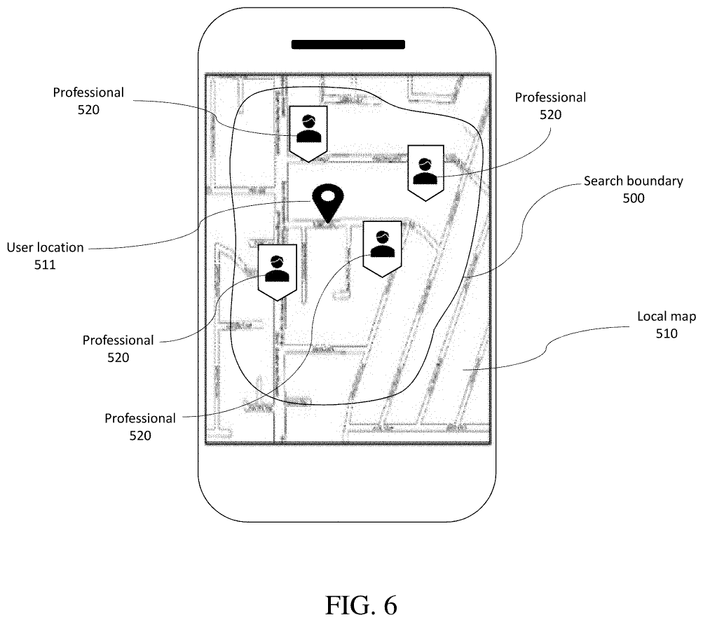

In some embodiments, the present invention may allow the user to draw a search boundary 500 on the local map 510 to locate a professional, as shown in FIG. 6, and the professionals 520 within the search boundary 500 can be shown on the local map 510. The local map 510 can also show the user location 511 where the user is located by using any GPS technology known in the art.

In some embodiments, the user can be also asked about a particular radius to generate the search boundary. Upon receiving the radius from the user, the communication step 122 may provide a map with the search boundary 500 which can be a circle of the radius given by the user with the user's current location as the center of the circle.

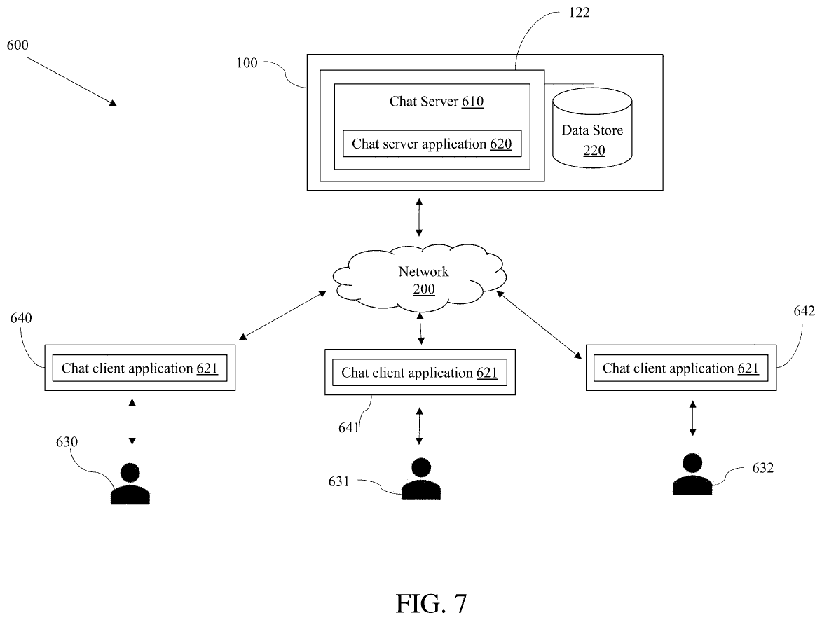

The communication step 122 may include a chat server 610 for facilitating communication between users, as shown in FIG. 7.

FIG. 7 presents a diagram illustrating an exemplary network environment 600 that includes a chat server 610, a chat server application 620, a chat client application 621, the data store 220, a number of chat participants 630-632 that can be the user or the professionals, and a network 200 that may correspond to any type of wired or wireless networks capable of coupling the computing devices (e.g., chat server 610 and the computing devices 640-642 for the chat participants 630-632).

Chat server 610 provides chat functionalities for one or more participants. In one embodiment, chat server 610 runs a chat server application 620 that utilizes instant messaging (IM) technology that offers real-time text transmission over the Internet. The instant messaging may include additional features such as audio and/or video so that during a chat session, the chat participants 630-632 can see each other by using webcams or other video cameras, and/or hear each other using microphones and speakers. Various types of messaging protocols may be used to communicate between the chat participants 630-632.

User and the professionals can communicate with each other via chat client applications 621 that run on the computing device 640-642 of the chat participants 630-632 (e.g., the user and the professionals) that can be any type of node on network with computational capability and mechanisms for communicating across the network 200. For example, the computing devices 640-642 used by the chat participants 630-632 can include a workstation, a personal computer (PC), a laptop computer, a tablet computer, a smartphone, and/or other electronic computing devices with network connectivity.

The communication step 122 may establish a chat session between the user and the selected professionals, where the chat session being executed using a chat application configured to transmit a plurality of messages between the user and the selected professionals. The user and the selected professionals can have a chat window that displays the messages. The chat application can be any communication application capable of transmitting and receiving messages between multiple users. The chat application may include the chat client application 621 and the chat server application 620. The chat application may be configured to send a variety of audio, video, and other information, including through image, video, text, and other file formats, including voicemails. In some embodiments, the chat server application 620 and the chat client application 621 may be configured to generate a list of professionals from the data store 220.

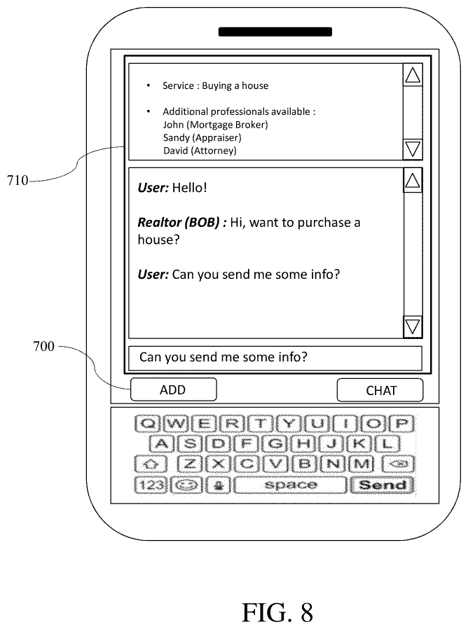

In some embodiments, as shown in FIG. 8, an add button 700 can be provided in the communication step 122 that allows the user to add any other professional to the chat session. For example, if the user (buyer) is chatting with a mortgage broker and the mortgage broker wishes to recommend a real estate agent, the user can add the real estate agent to the chat session, so that the real estate agent, the mortgage broker, and the user are all in the same chat session, able to communicate about how the house search is proceeding while exchanging relevant information.

Although most existing chat applications allow the user to share photos, audio, and video files, these features still require the user to communicate with other professionals that are related to the user's desired service. Thus, in addition to the basic communication function, the present invention provides a unique feature to automatically identify and add the service relate professionals to the chat session. For example, the communication step 122 may include a database configured to provide additional professionals related to the service selected by the user so that the communication step 122 can search the database automatically, during the chat session. If a home service is selected by the user, the database can provide plumbers, cleaners, landscapers, home designers as the additional professionals. If a real estate service (e.g., buying or selling house) is selected by the user, the database can provide mortgage brokers, real-estate agents, title companies, lawyers/attorneys, appraisers, insurance, home builders, engineers, home warranty, lenders, and inspectors as the additional professionals.

The communication step 122 may display the additional professionals available within the search boundary 500 (shown in FIG. 5) on the chat window 710 so that one or more additional professionals can be selected by the user. The communication step 122 may then add the additional professionals selected by the user to the chat session so that the user and the additional professionals can also communicate and exchange messages in the same chat session.

Whether a mortgage broker (who can be a user) wishes to connect with a real estate agent (who can be a professional) in the area, a user wants to get an estimate from a painter, or a user wishes to explore any of a range of home services, the real estate system of the present invention can help users connect with professionals who can facilitate the buying and selling of properties and provide related services.

In some embodiments, the communication step 122 (shown in FIG. 7) may display a list of professionals or their profile pages in a way that the user can view during the chat session. In some other embodiments, the communication step 122 (shown in FIG. 7) may also provide Internet search functionality through which users can locate any desired information, including local property news (e.g., open houses or property events) during the chat session.

In still other embodiments, the communication step 122 (shown in FIG. 7) may allow users to save transactions or professionals in their user accounts and rate professionals' services as a way of informing future potential buyers.

The steps and the processes described in connection with the embodiments disclosed herein can be embodied directly in hardware, in a software module executed by a processor, or in a combination of the two. A software module can reside in a memory unit that can include volatile memory, non-volatile memory, and network devices, or other data storage devices now known or later developed for storing information/data. The volatile memory may be any type of volatile memory including, but not limited to, static or dynamic, random access memory (SRAM or DRAM). The non-volatile memory may be any non-volatile memory including, but not limited to, ROM, EPROM, EEPROM, flash memory, and magnetically or optically readable memory or memory devices such as compact discs (CDs) or digital video discs (DVDs), magnetic tape, and hard drives.

The computing device may be a laptop computer, a cellular phone, a personal digital assistant (PDA), a tablet computer, and other mobile devices of the type. Communications between components and/or devices in the systems and methods disclosed herein may be unidirectional or bidirectional electronic communication through a wired or wireless configuration or network. For example, one component or device may be wired or networked wirelessly directly or indirectly, through a third party intermediary, over the Internet, or otherwise with another component or device to enable communication between the components or devices.

Examples of networks include, but are not limited to, a local area network (LAN), a wide area network (WAN), an enterprise's intranet, a virtual private network (VPN), and/or a combination of networks.

Examples of wireless communications include, but are not limited to, radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, 4G network, and other communication networks of the type. In example embodiments, network can be configured to provide and employ 5G wireless networking features and functionalities.

Although the invention has been explained in relation to its preferred embodiment, it is to be understood that many other possible modifications and variations can be made without departing from the spirit and scope of the invention.

What is claimed is:

1. A method comprising:
receiving registration information from a user;
providing a plurality of service listings to the user;
receiving a selection of a service from the user;
providing a local map showing the user's location;
receiving a search boundary from the user;
identifying first professionals within the search boundary for the selected service;
providing a plurality of listings of first professionals to the user;
receiving a selection from the user of one or more first professionals; and
establishing a chat session between the user and the selected first professionals, the chat session being executed using a chat application configured to transmit a plurality of first messages between the user and the selected first professionals, the first messages being displayed in a chat window local to the user.

2. The method as claimed in claim 1 comprising:
determining, based on the service selected by the user, whether the selected service requires additional second professionals and automatically generating a list of additional second professionals within the search boundary;
presenting simultaneously to both the user and the selected first professionals, the generated list of additional second professionals within the chat window;
receiving a selection of one or more additional second professionals from the user; and
adding the selected additional second professionals to the chat session that enables a plurality of second messages to be transmitted between the user and the selected additional second professionals, the second messages being displayed in the chat window local to the user.

3. The method as claimed in claim 1 comprising:
launching a first screen displaying: a start button; and
a second screen launched in response to the user pressing the start button on the first screen, the second screen displaying a registration form.

4. The method as claimed in claim 1, wherein the providing a plurality of listings of first professionals to the user further comprises:
providing a profile page of the first professional; and displaying a company information of the professional in response to the user clicking on the profile page.

5. The method as claimed in claim 1 comprising: receiving the registration information from the first professional.

6. The method as claimed in claim 5, wherein the registration information from the first professional includes advertiser information.

7. The method as claimed in claim 5, wherein the registration information from the first professional includes one or more verification numbers of the first professional.

8. The method as claimed in claim 1 comprising: receiving the registration information, at least in part, from an online search.

9. The method as claimed in claim 1 comprising: creating a password-protected account for the user.

10. The method as claimed in claim 1, wherein the search boundary is drawn on the local map by the user.

11. The method as claimed in claim 1, wherein the search boundary is determined by a radius given by the user.
